(19) United States
(12) Patent Application Publication
(10) Pub. No.: US 2012/0305829 A1
(43) Pub. Date: Dec. 6, 2012

(54) METHOD FOR MANUFACTURING DISORDERED POROUS SILICON DIOXIDE

(76) Inventors: Penghua ZHANG, Guangzhou (CN); Hui XU, Changsha (CN); Jianhua ZHANG, Guangzhou (CN)

(21) Appl. No.: 13/553,789

(22) Filed: Jul. 19, 2012

Related U.S. Application Data
(63) Continuation-in-part of application No. PCT/CN2012/000045, filed on Jan. 10, 2012.

(30) Foreign Application Priority Data
Jun. 5, 2011 (CN) 201110149858.0

(51) Int. Cl. C01B 33/12; C07F 7/18; H01F 1/42; C09K 3/00; B82Y 40/00

(52) U.S. Cl. 252/62.51 R; 252/182.12; 423/265; 556/450; 556/425; 556/429; 977/773; 977/774; 977/896

(57) ABSTRACT

A method for manufacturing a disordered porous silicon dioxide material including applying a fatty alcohol polyoxyethylene ether as an additive. The fatty alcohol polyoxyethylene ether has a formula of RO—(CH₂CH₂O)ₙ—H, R is C₈₋₂₄H₁₇₋₄₉, and n=9-30.

### CROSS-REFERENCE TO RELATED APPLICATIONS

This application is a continuation-in-part of International Patent Application No. PCT/CN2012/000045 with an international filing date of Jan. 10, 2012, designating the United States, now pending, and further claims priority benefits to Chinese Patent Application No. 201110149858.0 filed Jun. 5, 2011. The contents of all of the aforementioned applications, including any intervening amendments thereto, are incorporated herein by reference.

### BACKGROUND OF THE INVENTION

1. Field of the Invention

The invention relates to a method for manufacturing a disordered porous silicon dioxide material and a use of fatty alcohol polyoxyethylene ether in such a manufacturing method.

2. Description of the Related Art

According to the definition of the International Union of Pure and Applied Chemistry, the porous material can be classified into three types on the basis of the magnitude of pore size: a microporous material with a pore size of less than 2 nm, a macroporous material with a pore size of larger than 50 nm, and a mesoporous material with a pore size between 2 and 50 nm. On the basis of the feature of the pore structure, the porous material can be classified into an ordered porous material and a disordered porous material. In 1992, the researchers in Mobil Corporation made a break-through in the conventional technique in which a single solvated molecule or ion acts as a template during the synthesis of microporous zeolite molecular sieve, and succeeded in synthesizing the M41S series ordered aluminosilicate mesoporous material with a large specific surface area, regularly-arranged channels, and an adjustable pore size through the self-assembly function of organic/inorganic components in the solution. This series of ordered mesoporous material includes MCM-41, MCM-48, and MCM-50 layered structures. Thereafter, various synthesizing systems and synthesizing approaches have been proposed. The mesoporous material has been widely used for catalysis, adsorption and separation, micro-reactor, sensor, or the like.

During manufacturing of the disordered porous material, micrometer-scale silicon spheres with relatively uniform dimensions are manufactured as follows. TEOS are hydrolyzed to form cores, and then octadecyltrimethoxysilane and tetraethyl orthosilicate are added simultaneously for hydrolysis and condensation so as to form small spheres with a micrometer structure. The octadecyl is removed by firing, so as to form disordered mesoporous silicon dioxide. Thereafter, non-magnetic ferric oxide (Fe₂O₃) nano-particles with a dimension of 120 nm are employed, and octadecyltrimethoxysilane and tetraethyl orthosilicate are added for simultaneously for hydrolysis and condensation to deposit silicon species on the surface of Fe₂O₃ particle. Thus, a mesoporous silicon oxide outer shell by calcination is obtained, and finally a magnetic microsphere with a core of Fe₃O₄ and an outer shell of mesoporous SiO₂ by reducing at high temperature hydrogen is collected. The microsphere has a dimension of about 270 nm, a mesoporous pore size of about 3.8 nm, a specific surface of 283 m²/g, a hole volume of about 0.35 cm³/g, and a relatively strong magnetic response (27.3 emu/g), which greatly facilitates its applications. A conventional magnetic core/disordered mesoporous silicon dioxide shell manufactured by means of a self-assembly method has a diameter of about 300 nanometer, and the specific surface area of the mesoporous silicon sphere can be controlled by the amount of addition to the systems. As octadecyltrimethoxysilane which has a template function for forming mesoporous silicon dioxide increases in the amount of addition, the number of pores in each mesoporous microsphere in the systems increases, thus resulting in decrease in the dimension of mesopores and remarkably increase in the specific surface area. When the amount of addition reaches a certain amount, the pore size of mesoporous microspheres tends to maintain at a certain level.

However, during manufacturing of porous microspheres with nano-structure (including the research described above), it is commonly adopted in the art to provide a very high solvent ratio, in which a large amount of solvent is used to dilute the solute, so as to control the size of nano-scale microsphere and inhibit agglomeration, such as, microspheres with a size of 100-1000 nanometers (a solvent ratio of 1:5300), mesoporous microspheres with a size of 70 nanometers (a solvent ratio of 1:4000), mesoporous silicon spheres with a size of 30-50 nanometers with a solvent ratio of 1:2600, and highly-ordered silicon spheres with a size of about 120 nanometers with a solvent ratio of 1:1200. This kind of manufacturing method may greatly increase the manufacturing cost, because the large amount of reaction solvent can only produce few materials, thus making it not applicable for industrial production. Besides, the dispersity and uniformity in size are not ideal for the nano-particles produced by these methods.

Therefore, although the manufacturing of disordered porous silicon dioxide materials involves a relatively large range, the overall manufacturing is still in the early stage of development. In addition, it is well known that nano-particles tends to agglomerate and coagulate during reaction, so that it is impossible for particles to sufficiently disperse in the liquid media, and the particles are not uniform in size, thus greatly influence their practical applications. This phenomenon always occurred in the precedent researches. However in the literature up to now, these serious drawbacks have not or less been mentioned by the researchers. Therefore, there is no report regarding a good solution against agglomeration and coagulation in the prior art. In particular, there is no report regarding small particle mesoporous materials which have good dispersity, uniform size, and excellent performances to facilitating industrial production.

### SUMMARY OF THE INVENTION

The fatty alcohol polyoxyethylene ether associated with manufacturing of disordered porous silicon dioxide materials in the invention is used as a leveling agent in the prior art, has a trade name of Peregal O, and belongs to a class of nonionic surfactants. It has a strong leveling property, retarding ability, permeability, and diffusivity for various dyes, has scouring aiding performance during scouring, and can be used with various surfactants and dyes by dissolving with them. It has been widely applied in respective process for the textile dyeing industry. There is no related research which has indicated that when it is applied for manufacturing disordered porous silicon dioxide materials, the excellent effects in which the disordered porous silicon dioxide materials have good dispersity and uniform particle grain size can be achieved.

In view of the above-described problems, it is one objective of the invention to provide a method for manufacturing a disordered porous silicon dioxide material comprising applying a fatty alcohol polyoxyethylene ether. By using such an additive, it is possible for the resulting disordered porous silicon dioxide materials have uniform particle size and particle dispersity; what is more important is that the disordered porous materials are no longer available by means of a large amount of matched solvent. As a result, the bottleneck conditions in which too much solvent is needed during manufacturing are broken, so that the manufacturing of the disordered porous materials is applicable for industrial mass production.

To achieve the above objective, in accordance with one embodiment of the invention, there is provided a method for manufacturing a disordered porous silicon dioxide material comprising applying a fatty alcohol polyoxyethylene ether as an additive, wherein the fatty alcohol polyoxyethylene ether has a formula of RO—(CH₂CH₂O)ₙ—H, R is C₈₋₂₄H₁₇₋₄₉, and n=9-30.

The fatty alcohol polyoxyethylene ether is used as an additive for increasing particle dispersity of disordered porous silicon dioxide materials. The added fatty alcohol polyoxyethylene ether further enables the resulting disordered porous silicon dioxide materials to have good uniformity in particle size. The additive can increase solvent ratio during manufacturing, thus greatly reducing the required amount of solvent during manufacturing of disordered porous silicon dioxide materials. The solvent ratio in the invention refers to the mass ratio between the added raw material and the solvent.

The role of the fatty alcohol polyoxyethylene ether plays in manufacturing disordered porous silicon dioxide materials is as follows. Firstly, long-chain-alkyl silane is used as a template to form a certain steric configuration. Then, a silicon precursor such as tetraethyl orthosilicate hydrolyzes by taking the long-chain-alkyl silane as a kernel and gradually fills therebetween. At the same time, the fatty alcohol polyoxyethylene ether gradually grows and then forms a steric hindrance, which inhibits tetraethyl orthosilicate from accumulating continuously so as to prevent further growth of particle as well as fusion and adhesion between each other. In this way, even when the amount of solvent is reduced significantly, not only the material can still possess good dispersity (see FIGS. 3-4) and particle uniformity (see FIG. 5), but also it is possible to adjust the size by controlling the amount, synthesizing time, or the like. Reference is made to FIG. 1 for explaining the underlying mechanism.

In a class of this embodiment, the fatty alcohol polyoxyethylene ether has a formula of RO—(CH₂CH₂O)ₙ—H, wherein R is C₁₆₋₁₈H₃₃₋₃₇, and n=9-30.

In a class of this embodiment, the disordered porous silicon dioxide material comprises (A) a silicon dioxide material with a long-chain alkyl and a disordered microporous structure; (B) a silicon dioxide material with a disordered mesoporous structure; (C) modifying (A), (B) materials respectively to be connected with a functional group; or (D) embedding in (A), (B), or (C) material respectively with an inclusion material.

In a class of this embodiment, the number of C (carbon) in long-chain alkyl is not less than 8, and preferably 8-20.

In accordance with another embodiment of the invention, there is provided a method for manufacturing a disordered porous silicon dioxide material, the disordered porous silicon dioxide material comprising (A) a silicon dioxide material with a long-chain alkyl and a disordered microporous structure; (B) a silicon dioxide material with a disordered mesoporous structure; (C) modifying (A), (B) materials respectively to be connected with a functional group; or (D) embedding in (A), (B), or (C) material respectively with an inclusion material, and
the method for manufacturing the (A) material comprising hydrolyzing a raw material comprising a silicon precursor, long-chain-alkyl silane, and fatty alcohol polyoxyethylene ether in a solvent, and then ageing, filtering, and eluting;
the method for manufacturing the (B) material comprising hydrolyzing a raw material comprising a silicon precursor, long-chain-alkyl silane, and fatty alcohol polyoxyethylene ether in a solvent, and then ageing, filtering, drying, and calcining;
the method for manufacturing the (C) material in any one of the following two manners:
   1) adding a compound with a functional group into a raw material comprising a silicon precursor, long-chain-alkyl silane, and fatty alcohol polyoxyethylene ether; and hydrolyzing in a solvent and then ageing, filtering, and eluting to yield the (C) material, or hydrolyzing in a solvent and then ageing, drying, and calcining to yield the (C) material; or
   2) hydrolyzing any one of the resulting (A) and (B) materials in an organic silane with a functional group to yield the (C) material;
the method for manufacturing the (D) material in any one of the following two manners:
   1) adding a solvent in advance into an inclusion nano-particle which has been subject to dispersion treatment, then adding a raw material comprising a silicon precursor, long-chain-alkyl silane, and fatty alcohol polyoxyethylene ether, and hydrolyzing, ageing, filtering, and eluting to yield the (D) material, or hydrolyzing, ageing, filtering, drying, and calcining to yield the (D) material; or
   2) soaking any one of (A), (B) or (C) material in a precursor solution of the inclusion material, and diffusing, reacting, or reducing to yield the (D) material.

In a class of this embodiment, the long-chain-alkyl silane is selected from RnXS, wherein R represents alkyl, n is the number of C, which is not less than 8, preferably n=8-20, X is a group for hydrolyzing the silane, and S represents silicon.

In a class of this embodiment, the functional group comprises a functional group for purpose of coupling and/or modifying. By means of a functional group for coupling, an intermediate product is obtained; by means of the functional group for coupling on the intermediate product to connect a functional group for modifying, a silicon dioxide material modified with the functional group is obtained; or the functional group for modifying is connected directly with the silicon dioxide material.

In a class of this embodiment, the functional group comprises one or more of amino, sulfydryl, ethyoxyl, alkyl, mercaptopropyl, and methoxy.

In a class of this embodiment, the inclusion material comprises nanometer Au, Pt, light-emitting quantum dots, nanometer silicon spheres, or magnetic particles, so that the material has characteristics of light-emitting, magnetic response or the like.

In a class of this embodiment, the solvent involved in the invention is a conventional solvent for dissolving and dispersing the raw material during manufacturing of disordered porous silicon dioxide materials.

During manufacturing of the disordered porous silicon dioxide material in the invention, the primary raw materials for manufacturing comprise a silicon precursor, long-chain-alkyl silane, and Peregal O. In case of absence of a calcining step, a silicon dioxide material with a long-chain alkyl and with a microporous structure is obtained. While in case that the silicon dioxide material with a microporous structure is subject to calcining for removing the long-chain alkyl, a silicon dioxide material with a mesoporous structure is obtained.

In the manufacturing method described in the invention, the solvent ratio can be greatly increased (for example, in Example 2 of the invention, up to 1:55), while the manufactured material has a uniform size, the hole and particle size can be adjusted. Besides, the material has a good dispersity, and is absolutely applicable for industrial mass production.

The silicon dioxide material with a mesoporous structure, which is calcined to remove the long-chain alkyl, has a large pore volume and specific surface area. The specific surface area may amount to 1,366 m²/g, and the pore volume may amount to 1.31 cc/g. The large specific surface area and pore volume enable the silicon dioxide material to be widely applied in various professional fields.

The disordered porous silicon dioxide materials manufactured in the invention are nearly spherical silicon dioxide particles, the particle diameter may be in the range of 40-5,000 nanometers, and the particle mesoporous channels are arranged in a disordered manner. In the invention, an inclusion material like nanometer Au, Pt, light-emitting quantum dots, or magnetic particles may be embedded in the material in advance or introduced in mesoporous channels after material manufacturing. The mesoporous silicon dioxide material particles and channels may be connected with functional groups at the surface.

Specifically, the method for manufacturing the disordered porous silicon dioxide material comprises the following steps:
1) evenly mixing a solvent of water and alcohol, adding the prepared mixture of the silicon precursor, long-chain-alkyl silane, and Peregal O, stirring to mix evenly, then adding an acid/base like ammonia water or hydrochloric acid, and stirring continuously for hydrolyzing;
2) ageing, filtering, eluting, and drying the substance in step 1), to obtain a silicon dioxide material with a long-chain alkyl and a disordered microporous structure; and
3) calcining to remove long-chain alkyl so as to obtain a silicon dioxide material with a disordered mesoporous structure.

The functional group may be introduced during manufacturing of the disordered porous materials. The solvent like water, alcohol is mixed evenly, the prepared mixture of silicon precursor, long-chain-alkyl silane, and Peregal O is added to the solvent, stirred to mix evenly. Then an acid/base like ammonia water or hydrochloric acid, and the compound with a functional group to be connected are added, stirred continuously for hydrolyzing, and subject to ageing, filtering, eluting, and drying. As required, a calcining step is added or not added to remove template long-chain alkyl, thus yielding the corresponding product.

The functional group may be introduced after manufacturing of disordered porous materials. By hydrolyzing the organic silicon, a functional group for coupling is grafted and modified on the internal channels and outer surface of the product, thus yielding an intermediate product. By connecting a functional group for grafting with the functional group for coupling on the intermediate product, a product material grafted and modified with a functional group is obtained. Some functional groups can be directly grafted and is not necessary to be connected through an intermediate group for coupling.

The inclusion material like nanometer Au, Pt, light-emitting quantum dots, or magnetic particles may be introduced during manufacturing of disordered porous materials. An inclusion material precursor, which has been subject to dispersion treatment, is added in advance with a solvent like a mixture of water and alcohol and mixed evenly; a prepared mixture of silicon precursor, long-chain-alkyl silane, and nonionic long-chain surfactant is further added and stirred to mix evenly; then an acid/base like ammonia water or hydrochloric acid is further added and stirred continuously for hydrolyzing; a corresponding product is formed by ageing and filtering, in which a calcining step is added or not add as required to remove template long-chain alkyl.

The inclusion material like nanometer Au, Pt, light-emitting quantum dots, or magnetic particles may be introduced after manufacturing of disordered porous materials. The product in which the template is removed or not removed is soaked in a precursor solution of inclusion material. The material comprising the final inclusion material in holes is obtained by diffusing, reacting, or reducing.

In a class of this embodiment, the deionized water, alcohol, ammonia water or hydrochloric acid in the solvent have a volume ratio of 1:(0.1-30):(0.1-10).

In a class of this embodiment, the silicon precursor, long-chain silane, and nonionic surfactant have a molar ratio of 1:(0.1-10):(0.2-5).

In a class of this embodiment, tetraethyl orthosilicate (and other raw materials like sodium silicate which similarly serves for hydrolyzing) is applied as the silicon precursor.

In a class of this embodiment, the long-chain-alkyl silane is preferably selected from RnXS, wherein R represents alkyl, n represents the number of C=8, 10, 12, 14, 16, 18, or 20, and R includes normal or heterogeneous alkyls obvious for the skilled in the art. After the template long-chain alkyl is removed, mesoporous materials with different pore size, pore volume, and specific surface area are obtained. X refers to the group in these silanes for hydrolyzing. In a manner which is apparent for the skilled in the art, since these groups are eventually removed during silane hydrolyzing, their presence and difference only indicate difference in choosing the process during hydrolyzing, and all of the final products are RnSiO₂.

In a class of this embodiment, in step 1), the preparation reaction is conducted at room temperature (RT).

In a class of this embodiment, in step 1), the stirring time for the preparation reaction is 2-24 hours.

In a class of this embodiment, in step 2), ageing is conducting under RT for 1-24 hours.

In a class of this embodiment, in step 2), separation is conducted by filtering or centrifugal separation.

In a class of this embodiment, in step 2), drying is conducted under RT for 1-24 hours.

In a class of this embodiment, in step 2), the template is removed by firing, the heating rate is 0.1-30° C./min, and the temperature is maintained at 200-700° C. for 2-20 hours. By means of extraction, the extraction is conducted with 70° C. alcohol for 48-120 hours.

In a class of this embodiment, the functional groups for modifying and grafting are various organic silane coupling agents, and react by dehydration condensation with hydroxyl which is rich on the surface of the disordered porous materials, thus forming Si—O—Si bonds which are connected at the surface of the disordered porous materials.

As compared with the resulting material of the prior art, the disordered porous silicon dioxide materials manufactured by using the invention have the outstanding features and significant improvement in that they have excellent dispersity, uniform size for the material particle, low tendency of large difference in particle size during manufacturing of this type of material in the existing methods. Besides, the size can be adjusted, and the manufacturing process is simple and has a relatively short production cycle. The bottleneck conditions in which too much solvent is needed during manufacturing are broken, so that it is easy to implement industrial mass production. Furthermore, the material may be embedded in advance, or an inclusion material like nanometer metal, light-emitting quantum dots, and magnetic particle may be introduced in mesoporous channels after preparation of the material, so that material has a characteristic like light-emitting, magnetic response or the like. In addition, the surface functional group may also be modified during preparation or after preparation, thus greatly expanding the application field.

### BRIEF DESCRIPTION OF THE DRAWINGS

FIG. 1. is a schematic diagram showing the synthesizing mechanism of a disordered micropore silicon dioxide material;

FIG. 2. is a schematic diagram showing the molecule structure of a disordered micropore silicon dioxide material (A);

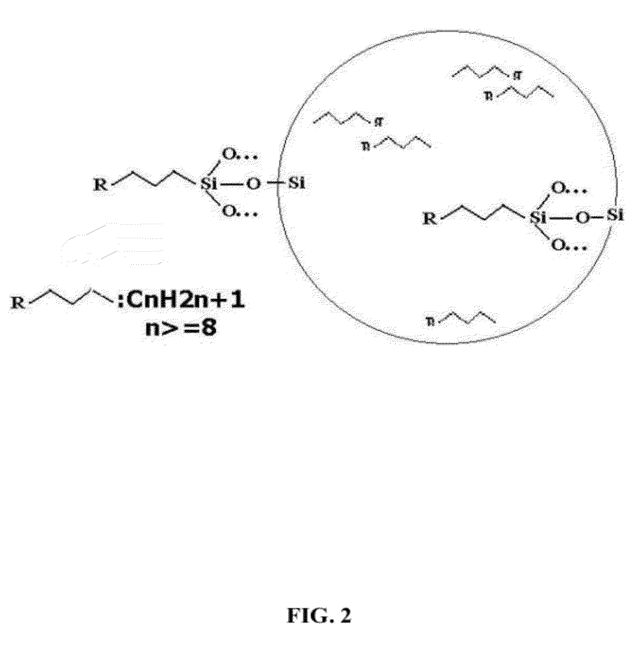

FIG. 3 shows TEM photographs of a disordered micropore silicon dioxide material which is not added and added with Peregal (a: a TEM photograph showing Peregal is not added to the material, b: a TEM photograph showing Peregal is added to the material, see Example 1);

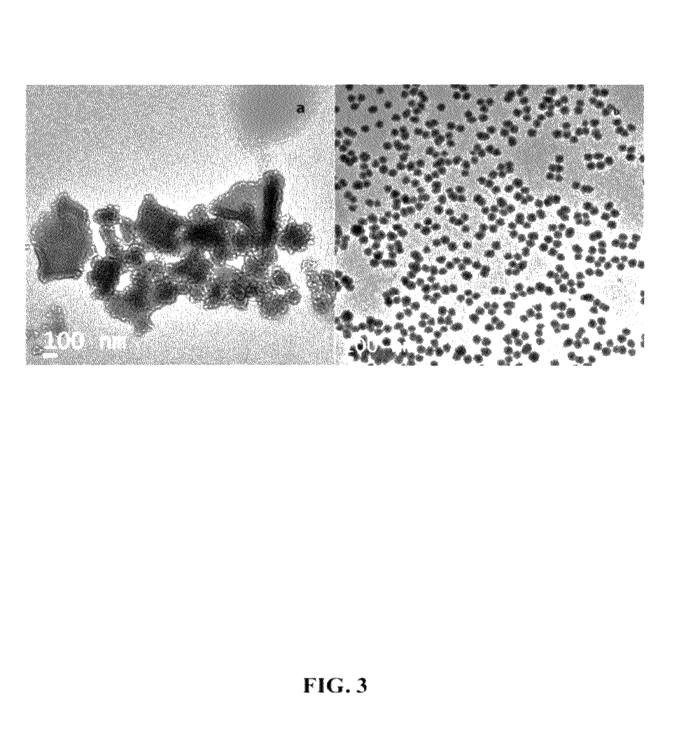

FIG. 4 shows TEM photographs of a disordered micropore silicon dioxide material which is not calcined and is calcined; a1: a global TEM showing the material which is not calcined and has a disordered microporous structure, a2: a local TEM showing the material which is not calcined and has a disordered microporous structure, b1: a global TEM showing the material which is calcined and has a mesoporous structure, b2: a global TEM showing the material which is calcined and has a mesoporous structure;

FIG. 5 is a particle size distribution statistical graph for a disordered microporous structure silicon dioxide material to which Peregal is added by using the method of the invention; it can be seen from this figure that the particle size of the resulting material in the invention is distributed within a narrow region, which demonstrates that the resulting particle size is very uniform;

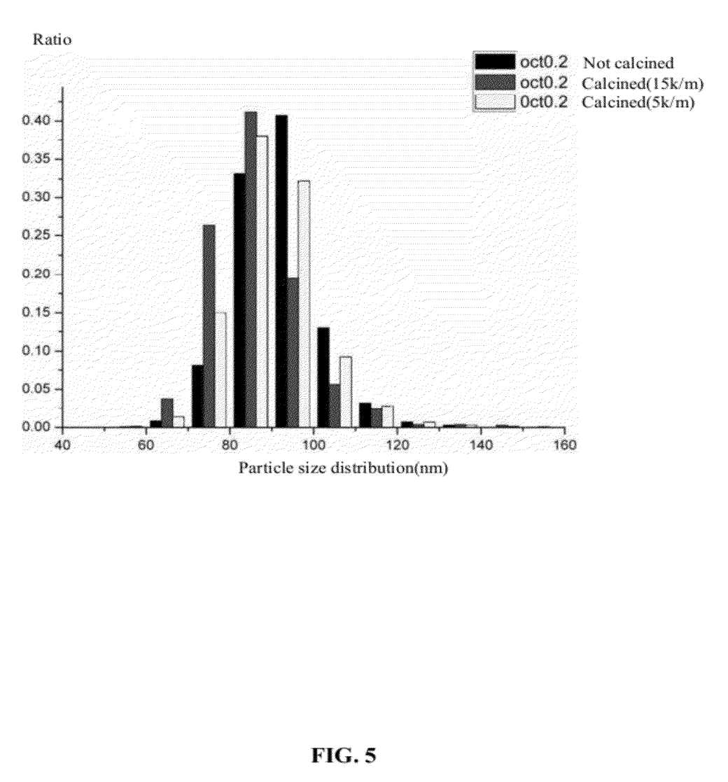

FIG. 6 is a TEM for typical morphology for a disordered mesoporous silicon dioxide material manufactured by using the method of the invention;

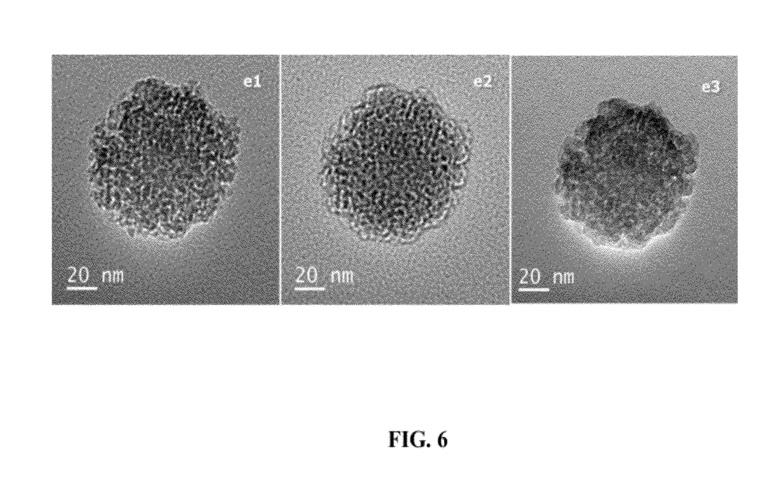

FIG. 7 is a liquid nitrogen adsorption/desorption graph for a disordered microporous structure silicon dioxide material manufactured by using the method of the invention; and

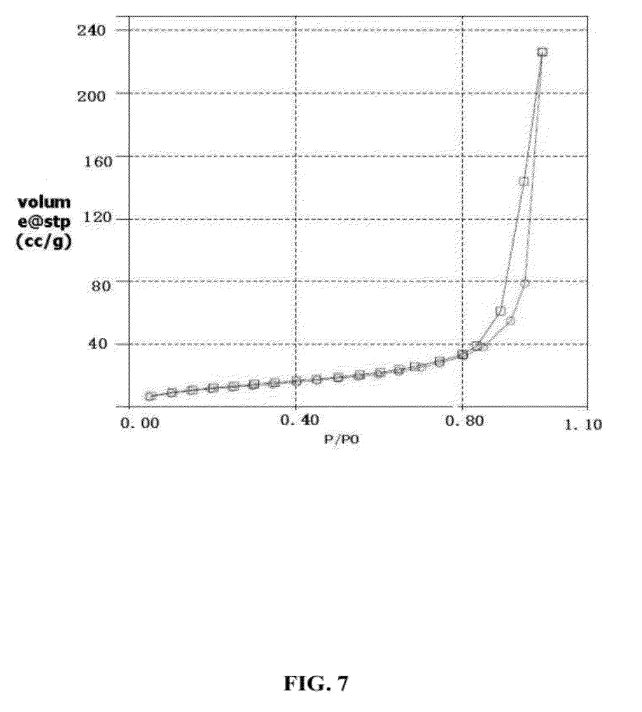

FIG. 8 is a liquid nitrogen adsorption/desorption graph for a disordered mesoporous structure silicon dioxide material manufactured by using the method of the invention.

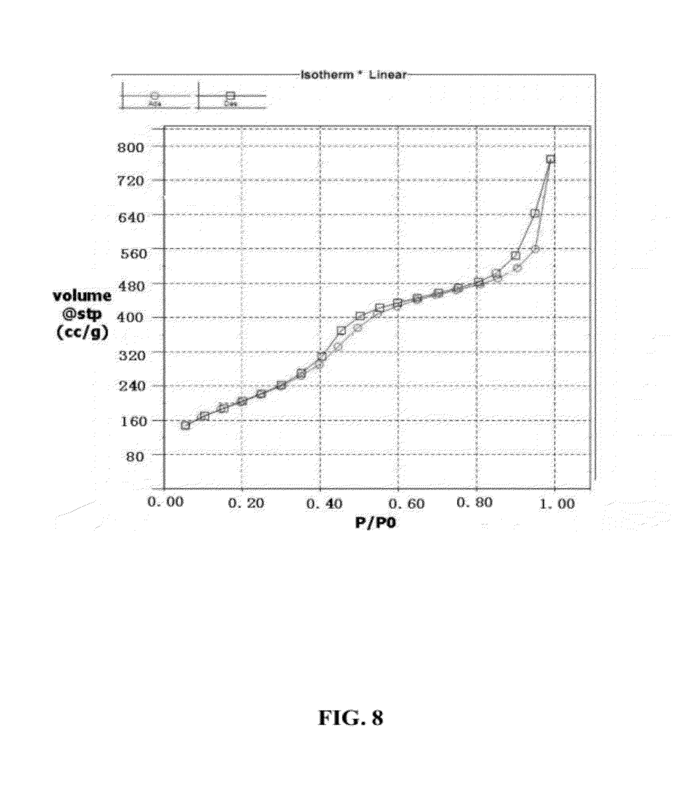

### DETAILED DESCRIPTION OF THE EMBODIMENTS

For further illustrating the invention, experiments detailing a method for manufacturing a disordered porous silicon dioxide material are described below. It should be noted that the following examples are intended to describe and not to limit the invention.

### Example 1

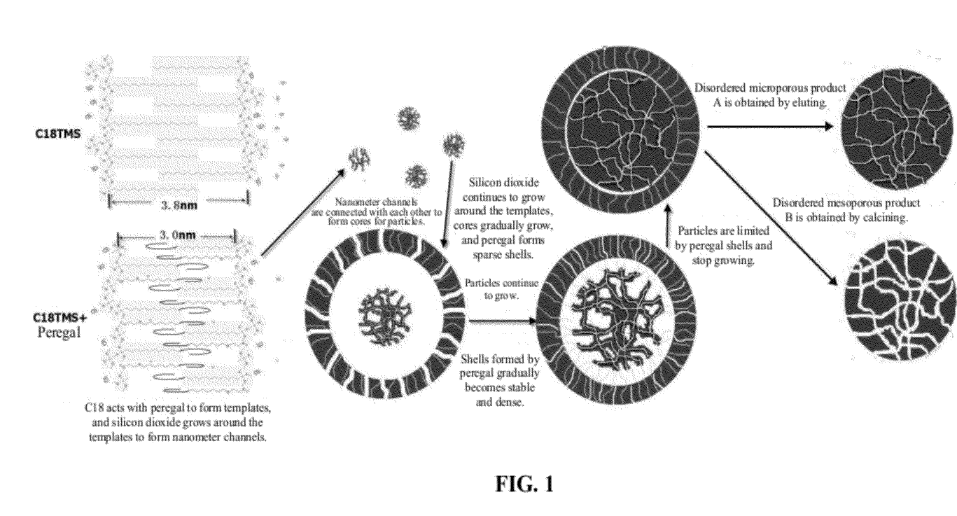

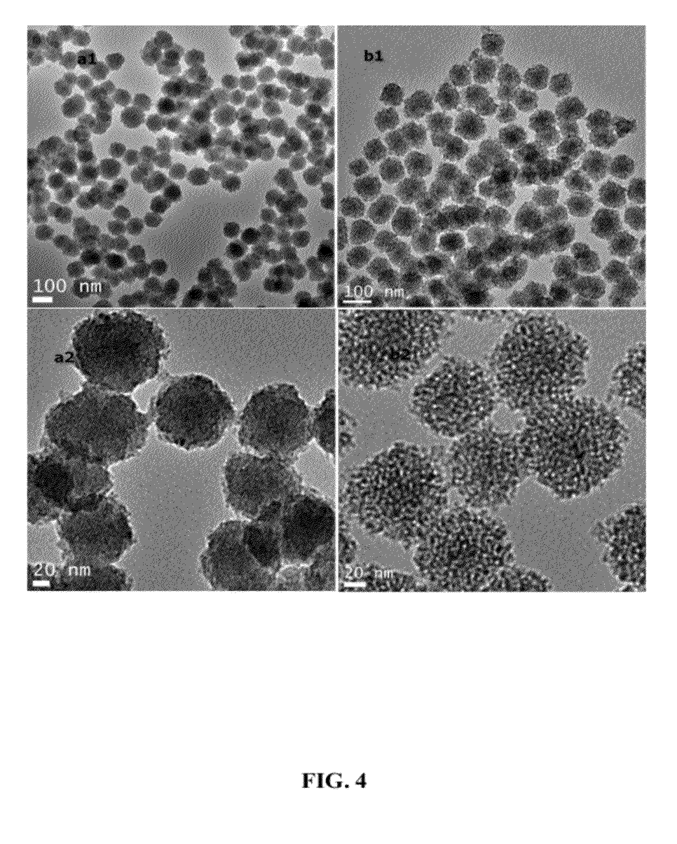

Deionized water, alcohol, and ammonia water are taken by volume of 1000:1750:310 mL to prepare a solvent. Tetraethyl orthosilicate, octadecyltrimethoxysilane, and Peregal O25 are weighed in the following amounts—7 grams:10 grams:6 grams, respectively, mixed and added to the solvent, and stirred continuously for 48 hours, then aged for 48 hours under RT, filtered with a filter paper, and then dried under RT for 48 hours. The grinded white powder is the silicon dioxide material with a long-chain alkyl and a disordered microporous structure as prepared. FIG. 4 shows in a1, a2 the TEM pictures of the material of this example in which the template has not been removed. In a1 of FIG. 4, the global TEM picture may demonstrate that this material has an excellent mono-dispersity and remarkably uniform material particle size. During preparation the sample for TEM imaging of this material, only the ultrasonic vibration is conducted and no dispersing agent is used to help dispersing the material. In a2 of FIG. 1, some local enlarged pictures are shown, indicating a particle size of about 100 nanometers.

### Example 2

Deionized water, alcohol, and ammonia water are taken by volume of 400:750:120 mL to prepare a solvent. Tetraethyl orthosilicate, octadecyltrimethoxysilane, and Peregal O16 are weighed in the following amounts—7 grams:10 grams:6 grams respectively, mixed and added to the solvent, and stirred continuously for 48 hours, then aged for 48 hours under RT, filtered with a filter paper, and then dried under RT for 48 hours. The dried product is transferred to a crucible and then put into a muffle furnace, ramped in temperature at 3° C./min, and maintained at a temperature of 600° C. for 8 hours. After natural cooling, the resulting white powder is the mesoporous material as prepared. FIG. 4 shows in b1, b2 the TEM pictures of the mesoporous material of this example. In b1 of FIG. 4, the global TEM picture may demonstrate that this material has an excellent mono-dispersity and remarkably uniform material particle size. During preparation the sample for TEM imaging of this material, only the ultrasonic vibration is conducted and no dispersing agent is used to help dispersing the material. In b2 of FIG. 4, some local enlarged pictures are shown, indicating a particle size of about 100 nanometers. There are distinct irregular channels inside the material, but the pore size is also uniform.

### Example 3

Deionized water, alcohol, ammonia water are taken by volume of 1000:1750:780 mL to prepare a solvent. Tetraethyl orthosilicate, hexadecyltrimethoxysilane, and Peregal O-10 are weighed in the following amounts—7 grams:9 grams:6 grams respectively, mixed and added to the solvent, and stirred continuously for 48 hours, then aged for 48 hours under RT, filtered with a filter paper, and then dried under RT for 48 hours. The grinded white powder the silicon dioxide material with a long-chain alkyl and with a microporous structure as prepared.

### Example 4

Deionized water, alcohol, ammonia water are taken by volume of 1000:1750:780 mL to prepare the solvent. Tetraethyl orthosilicate, hexadecyltrimethoxysilane, and Peregal O25 are weighed in the following amounts—7 grams:9 grams:6 grams respectively, mixed and added to the solvent, and stirred continuously for 48 hours, then aged for 48 hours under RT, filtered with a filter paper, and then dried under RT for 48 hours. The dried product is transferred to a crucible and then put into a muffle furnace, ramped in temperature at 3° C./min, and maintained at a temperature of 600° C. for 8 hours. After natural cooling, the resulting white powder is the mesoporous material as prepared.

### Example 5

Deionized water, alcohol, ammonia water are taken by volume of 1000:1750:780 mL to prepare the solvent. Tetraethyl orthosilicate, dodecyltrimethoxysilane, and Peregal O25 are weighed in the following amounts—7 grams:8 grams:6 grams respectively, mixed and added to the solvent, and stirred continuously for 48 hours, then aged for 48 hours under RT, filtered with a filter paper, and then dried under RT for 48 hours. The dried product is transferred to a crucible and then put into a muffle furnace, ramped in temperature at 3° C./min, and maintained at a temperature of 600° C. for 8 hours. After natural cooling, the resulting white powder is the mesoporous material as prepared.

### Example 6

Deionized water, alcohol, hydrochloric acid are taken by volume of 1000:1750:920 mL to prepare the solvent. Tetraethyl orthosilicate, dodecyltrimethoxysilane, and Peregal O25 are weighed in the following amounts—7 grams:8.6 grams:6 grams respectively, mixed and added to the solvent, and stirred continuously for 48 hours, then aged for 48 hours under RT, filtered with a filter paper, and then dried under RT for 48 hours. The dried product is transferred to a crucible and then put into a muffle furnace, ramped in temperature at 3° C./min, and maintained at a temperature of 600° C. for 8 hours. After natural cooling, the resulting white powder is the mesoporous material as prepared.

### Example 7

Deionized water, alcohol, ammonia water are taken by volume of 700:1250:215 mL to prepare the solvent. Tetraethyl orthosilicate, octadecyltrimethoxysilane, and Peregal O16 are weighed in the following amounts—7 grams:10 grams:6 grams respectively, mixed and added to the solvent, and stirred continuously for 48 hours, then aged for 48 hours under RT, filtered with a filter paper, and then dried under RT for 48 hours. The grinded white powder is the silicon dioxide material with a long-chain alkyl and with a microporous structure as prepared.

### Example 8

This example is based on the method of Example 1, 2, or 3, except that the solvent in the raw material is added in advance into 30 mL nanometer ferroferric oxide magnetic fluid which has been subject to dispersion treatment and has a concentration of 30 milligram/mL. By calcining in the muffle furnace, and reducing by hydrogen at 600° C. for 10 hours, a material with embedded magnetic core and mesoporous shell is obtained.

### Example 9

3 grams tetraethyl orthosilicate is added in advance into a solvent of deionized water, alcohol, and ammonia water and hydrolyzes for 2 hours. Then the following steps are conducted in light of the method of Example 1, and the resulting core is a silicon dioxide material with a nanometer silicon sphere.

### Example 10

This example is based on the method of Example 1, 2, or 3, and a powder mesoporous material is obtained. Then, 2 grams of the powder mesoporous material is soaked in a solution of 2 mol/l Fe³⁺ and Fe²⁺ slats, vibrated in a shaking table for 72 hours, separated by centrifugal separation, and then reduced by hydrogen at 600° C. for 10 hours. The resulting mesoporous silicon dioxide material contains magnetic particle in mesopores.

### Example 11

This example is based on the method of Example 1, 2, or 3, except that after being stirred continuously for 12 hours, 2.6 mL amino silane such as APTES is added, and after RT drying, it is impossible to calcine to avoid being burnt away along with the amino group. It is only possible to apply extraction for removing the template and maintaining the amino group. As a result, the mesoporous silicon dioxide material grafted with amino is obtained.

### Example 12

This example is based on the method of Example 1, 2, or 3, except that after being stirred continuously for 12 hours, sulfydryl silane such as 2.3 mL γ-mercaptopropyl tryi-ethyoxyl silane is added, and after RT drying, it is impossible to calcine to avoid being burnt away along with the amino group. It is only possible to apply extraction for removing the template and maintaining the amino group. As a result, the mesoporous silicon dioxide material grafted with sulfydryl is obtained.

### Example 13

This example is based on the method of Example 1, 2, or 3, and a powder mesoporous material is obtained. Then, 3.3 grams of the material is subjected to ultrasonic dispersion in the reaction solvent such as dimethylbenzene. 3.5 mL Amino silane APTES is added, and is stirred continuously under temperature 120° C. for 48 hours. After filtering, washing, and drying, the mesoporous material descendent grafted with amino is obtained.

### Example 14

This example is based on the method of Example 1, 2, or 3, and a powder mesoporous material is obtained. Then, 3.9 grams of the material is subjected to ultrasonic dispersion in the reaction solvent such as dimethylbenzene. 4.3 mL organic silicon source of γ-mercaptopropyl tri-ethyoxyl silane is added, and is stirred continuously under temperature 120° C. for 48 hours. After filtering, washing, and drying, the mesoporous material descendent grafted with sulfydryl is obtained.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for manufacturing a disordered porous silicon dioxide material comprising admixing a fatty alcohol polyoxyethylene ether as an additive, wherein the fatty alcohol polyoxyethylene ether has a formula of RO—(CH₂CH₂O)ₙ—H, and R is C₈₋₂₄H₁₇₋₄₉, and n=9-30.

2. The method claim 1, wherein R is C₁₆₋₁₈H₃₃₋₃₇.

3. The method of claim 1, wherein the additive increases a solvent ratio during the manufacturing process, and the solvent ratio refers to the mass ratio between added raw materials and a solvent in the manufacturing process.

4. The method of claim 1, wherein the additive increases particle dispersity and uniformity of particle size of the disordered porous silicon dioxide material.

5. The method claim 1, wherein the disordered porous silicon dioxide material comprises (A) a silicon dioxide material with a long-chain alkyl and a disordered microporous structure; (B) a silicon dioxide material with a disordered mesoporous structure; (C) modifying the (A), (B) materials respectively to be connected with a functional group; or (D) embedding in the (A), (B), or (C) material respectively with an inclusion material.

6. The method claim 5, wherein the number of carbon atoms of the long-chain alkyl is not less than 8.

7. The method claim 5, wherein the functional group comprises a functional group for coupling and/or modifying.

8. The method claim 7, wherein the functional group comprises amino, sulfydryl, ethyoxyl, alkyl, mercaptopropyl, methoxy, or a mixture thereof.

9. The method claim 5, wherein the inclusion material comprises nanometer Au, Pt, light-emitting quantum dots, nanometer silicon spheres, or magnetic particles.

10. A method for manufacturing a disordered porous silicon dioxide material, the disordered porous silicon dioxide material comprising (A) a silicon dioxide material with a long-chain alkyl and a disordered microporous structure; (B) a silicon dioxide material with a disordered mesoporous structure; (C) modifying (A), (B) materials respectively to be connected with a functional group; or (D) embedding in the (A), (B), or (C) material respectively with an inclusion material, and a raw material used for manufacturing the disordered porous silicon dioxide materials comprising a silicon precursor, long-chain-alkyl silane, and fatty alcohol polyoxyethylene ether; the fatty alcohol polyoxyethylene ether being represented by a formula of RO—(CH₂CH₂O)ₙ—H, of which R is C₈₋₂₄H₁₇₋₄₉, n=9-30, and
a) the method for manufacturing the (A) material comprising hydrolyzing the raw material comprising the silicon precursor, long-chain-alkyl silane, and fatty alcohol polyoxyethylene ether in a solvent, and ageing, filtering, and eluting;
b) the method for manufacturing the (B) material comprising hydrolyzing the raw material comprising the silicon precursor, long-chain-alkyl silane, and fatty alcohol polyoxyethylene ether in a solvent, and ageing, filtering, drying, and calcining;
c) the method for manufacturing the (C) material in any one of the following two manners:
1) adding a compound with a functional group into the raw material comprising the silicon precursor, long-chain-alkyl silane, and fatty alcohol polyoxyethylene ether; and hydrolyzing in a solvent and then ageing, filtering, and eluting to yield the (C) material, or hydrolyzing in a solvent and then ageing, drying, and calcining to yield the (C) material; or
2) hydrolyzing any one of the resulting (A) and (B) materials in an organic silane with a functional group to yield the (C) material;
d) the method for manufacturing the (D) material in any one of the following two manners:
1) adding a solvent in advance into an inclusion nano-particle which has been subject to dispersion treatment, then adding the raw material comprising the silicon precursor, long-chain-alkyl silane, and fatty alcohol polyoxyethylene ether, and hydrolyzing, ageing, filtering, and eluting to yield the (D) material, or hydrolyzing, ageing, filtering, drying, and calcining to yield the (D) material; or
2) soaking any one of the (A), (B), or (C) material in a precursor solution of the inclusion material, and diffusing, reacting, or reducing to yield the (D) material.

11. The method of claim 10, wherein the long-chain-alkyl silane is selected from RnXS, R represents alkyl, n represents the number of carbon atoms in the alkyl, which is not less than 8, X is a group for hydrolyzing the silane, and S represents silicon.

12. The method of claim 10, wherein the functional group comprises a functional group for coupling and/or modifying.

13. The method of claim 12, wherein the functional group comprises amino, sulfydryl, ethyoxyl, alkyl, mercaptopropyl, methoxy, or a mixture thereof.

14. The method of claim 10, wherein the inclusion material comprises nanometer Au, nanometer Pt, light-emitting quantum dots, nanometer silicon spheres, or magnetic particles.

15. The method of claim 10, wherein the solvent comprises deionized water, alcohol, and ammonia water or hydrochloric acid with a volume ratio of 1:(0.1-30):(0.1-10).

16. The method of claim 10, wherein the silicon precursor, long-chain-alkyl silane, and the fatty alcohol polyoxyethylene ether have a molar ratio of 1:(0.1-10):(0.2-5).

17. The method of claim 10, wherein the silicon precursor is tetraethyl orthosilicate.

18. The method of claim 10, wherein the ageing is conducted under room temperature for 1-24 hours.

19. The method of claim 10, wherein the drying is conducted under room temperature for 1-24 hours.

20. The method of claim 10, wherein during the calcining, the heating rate is 0.1-30° C./min, and the temperature is maintained at 200-700° C. for 2-20 hours.
